(19) United States
(12) Patent Application Publication
(10) Pub. No.: US 2026/0077755 A1
(43) Pub. Date: Mar. 19, 2026

(54) Hybrid Vehicle

(71) Applicants: Deutsche Post AG, Bonn (DE); Scania CV AB, Södertälje (SE)

(72) Inventors: Tobias Meyer, Bad Honnef (DE); Jörg Salomon, Bonn (DE); Michael Lohmeier, Rheinbach (DE); Kaj Hanson, Rönninge (SE); Anders Ställberg, Tullige (SE); Johan Malm Haglund, Hägersten (SE)

(21) Appl. No.: 19/332,169

(22) Filed: Sep. 18, 2025

(30) Foreign Application Priority Data
Sep. 19, 2024 (DE) 10 2024 127 035.7

(51) Int. Cl. B60W 10/08; B60W 20/16

(52) U.S. Cl. CPC B60W 10/08; B60W 20/16; B60W 2300/12; B60W 2510/06; B60W 2530/18

(57) ABSTRACT

A hybrid vehicle and a method, in particular for the transportation of general cargo or shipments, including an electric motor for moving the hybrid vehicle, a battery, wherein the battery is connected to the electric motor and supplies the electric motor with power. Furthermore, the hybrid vehicle includes a generator unit, wherein the generator unit includes an internal combustion engine and a generator connected to the internal combustion engine, wherein the generator converts the kinetic energy of the internal combustion engine into power to operate the electric motor or for storage in the battery. A control unit is connected to the generator unit and is also configured to determine the distance traveled by the hybrid vehicle. The control unit is also configured to control the generator unit dependent on the distance traveled by the hybrid vehicle.

### CROSS-REFERENCE TO RELATED APPLICATION

This application claims priority to German Patent Application No. 10 2024 127 035.7 filed Sep. 19, 2024, the disclosure of which is hereby incorporated by reference in its entirety.

### BACKGROUND OF THE INVENTION

### Field of the Invention

The present invention relates to a hybrid vehicle, in particular for the transportation of general cargo or shipments. Furthermore, the present invention relates to a method for reducing the emissions of a hybrid vehicle and a method for operating a fleet of vehicles comprising such a hybrid vehicle.

### Description of Related Art

Known hybrid vehicles comprise an electric motor to move the hybrid vehicle or to be more precise the drive wheels of the hybrid vehicle. A battery is connected to the electric motor and supplies it with power to operate the electric motor. Well-known hybrid vehicles also have an internal combustion engine. Here, the kinetic energy of the internal combustion engine can be used directly to move the hybrid vehicle or to be more precise to move the drive tires of the hybrid vehicle. Alternatively, there are hybrid vehicles in which the internal combustion engine is part of a generator unit. By means of the generator unit, the kinetic energy of the internal combustion engine is converted into power by a generator of the generator unit, which is then used to charge the battery or to supply the electric motor with power. Such a generator unit is also referred to as a “range extender”, as the generator unit increases the range of the hybrid vehicle. This configuration of a hybrid vehicle is also known as a serial hybrid vehicle. Especially, there is no direct/mechanical connection between the generator unit and the drive wheels of the hybrid vehicle.

To reduce the emissions of a hybrid vehicle, it is necessary for the hybrid vehicle to use only the electric motor as often as possible, supplied with the power from the battery, without the internal combustion engine of the generator unit being activated. However, it has been shown that the generator unit is usually used in the sense of a conventional combustion vehicle and that the battery of the hybrid vehicle is predominantly charged only by means of the generator unit. Here, the hybrid vehicle is not operated in the sense of an electric vehicle, or only to a limited extent. However, this increases the emissions caused by the hybrid vehicle and the specified limit values for emissions, and in particular the emission of CO₂ by the hybrid vehicle can no longer be complied with. This runs counter to the aim of reducing emissions through the use of a hybrid vehicle, so that the increased weight of a hybrid vehicle by providing the battery and the electric motor as well as the generator of the generator unit additionally has a negative effect on the emissions of the hybrid vehicle. The advantages of using a hybrid vehicle thus turn into disadvantages.

The object of the present invention is to provide a hybrid vehicle with reduced emissions.

### SUMMARY OF THE INVENTION

The object is achieved with a hybrid vehicle, a method, and a method for operating a fleet of vehicles described herein.

The hybrid vehicle according to the invention, in particular for the transportation of general cargo or shipments, comprises an electric motor for moving the hybrid vehicle. Here, the electric motor is mechanically connected to the drive wheels of the hybrid vehicle so that the mechanical movement of the electric motor is used directly to drive the hybrid vehicle. Furthermore, the hybrid vehicle comprises a battery, wherein the battery is connected to the electric motor and supplies the electric motor with power. Furthermore, the hybrid vehicle comprises a generator unit, wherein the generator unit comprises an internal combustion engine and a generator connected to the internal combustion engine. The generator converts the kinetic energy of the internal combustion engine into power. The power generated by the generator unit is then used to operate the electric motor or can be stored in the battery. In particular, the generator unit or to be more precise the internal combustion engine of the generator unit has no mechanical connection to the drive wheels of the hybrid vehicle. This means that the kinetic energy of the internal combustion engine is not used mechanically to move the hybrid vehicle. This is therefore a serial hybrid vehicle and the generator unit works in the sense of a “range extender”. On the one hand, the hybrid vehicle's battery can therefore be charged via a cable connection to a power grid. Alternatively, the generator unit can be used to charge the battery and thus for the power supply of the electric motor.

According to the invention, the hybrid vehicle comprises a control unit, wherein the control unit is connected to the generator unit and is also configured to determine the distance traveled by the hybrid vehicle. In accordance with the invention, the control unit is also configured to control the generator unit dependent on or as a function of the distance traveled by the hybrid vehicle. For example, the generator unit can be activated by the control unit if the hybrid vehicle has traveled a specified minimum distance purely electrically. Only then can the generator unit be switched on by the control unit. This prevents that in particular short distance journeys are made with the support of the internal combustion engine of the generator unit. Alternatively or additionally, the generator unit can be switched off by the control unit or an activation of the generator unit can be prevented if the hybrid vehicle has traveled a specified distance. The control unit, which controls the generator unit as a function of the distance traveled by the hybrid vehicle, thus controls the generator unit and thus the hybrid vehicle such that the emissions of the hybrid vehicle are kept low. In other words, the operation of the hybrid vehicle as a purely electric vehicle, which obtains its electrical energy exclusively from the battery without using the generator unit as a “range extender”, is maximized and thus the emissions of the hybrid vehicle are minimized.

Preferably, the hybrid vehicle is a truck. In particular, the hybrid vehicle has a permissible total mass of more than 3.5 tons and preferably more than 7.5 tons. It is particularly difficult to reduce emissions in heavy vehicles, although the present invention can also achieve a suitable reduction in emissions for these vehicles. It should be noted in particular that trucks are used both in long-distance traffic, where it makes sense to activate the generator unit, and in short-distance traffic, where an activation of the generator unit should be avoided as far as possible. Preferably, the hybrid vehicle is a swap body vehicle.

Preferably, the control unit is configured to control the generator unit dependent on or as a function of the distance traveled by the hybrid vehicle with the generator unit activated. The control unit therefore detects the distance traveled by the hybrid vehicle with the generator unit activated, i.e. the distance traveled by the hybrid vehicle in which the hybrid vehicle generates emissions. Thus, in particular an activation of the generator unit by the control unit can be prevented or the generator unit can be switched off by the control unit if the distance traveled by the hybrid vehicle with the generator unit being activated exceeds a specified limit value. This means that unlimited operation of the generator unit and thus using the hybrid vehicle as a classic combustion vehicle is ruled out. If the activation of the generator unit is prevented by the control unit or the generator unit is switched off by the control unit, the electric motor of the hybrid vehicle is powered exclusively by the power stored in the battery. Therefore, if the battery is empty, it is necessary to charge it in the sense of an electric vehicle by connecting the hybrid vehicle and thus the battery to a power grid. Thus, the hybrid vehicle according to the present invention retains the advantages of a hybrid vehicle by increasing the range, whereas using the hybrid vehicle in the sense of a conventional combustion vehicle and the resulting increased emissions are prevented. Emission limit values can thus be effectively complied with by the control unit, as the use of the internal combustion engine is restricted by the specified limit value.

Here, the specified limit value can include a distance traveled by the hybrid vehicle, a distance traveled with the generator unit activated or a ratio of the distance traveled to the distance traveled with the generator unit activated.

Preferably, the generator unit is activated in the conventional manner dependent on or as a function of the charge state of the battery. This means that the generator unit can be switched on when the charge level of the battery falls below a certain level due to the battery being discharged by the electric motor supply. The generator unit can be activated in the conventional manner dependent on or as a function of the charge state of the battery. Alternatively or additionally, the generator unit can be activated if more power is required for the electric motor than can be supplied by the battery, for example by a performance requirements for the electric motor by the user. However, according to the present invention, such an activation of the generator unit by the control unit can be prevented as described above, so that unnecessary or impermissible emissions can be prevented by using the generator unit.

Preferably, the control unit is configured to control the generator unit dependent on or as a function of the emissions generated by the hybrid vehicle over the distance traveled. In particular, the control unit is configured to determine the emissions of the generator unit, for example on the basis of fuel consumption and/or other engine parameters. These engine parameters can include, for example, the rotational speed of the internal combustion engine of the generator unit or the like. Here, in particular an activation of the generator unit by the control unit can be prevented if the emissions generated by the hybrid vehicle over the distance traveled exceed a specified limit value. This ensures that the emissions generated by the hybrid vehicle over a distance traveled are reduced and that unrestricted operation of the generator unit and thus using the hybrid vehicle in the sense of a conventional combustion vehicle is excluded. In particular, it is possible to consider specified emission limit values. In particular, the specified limit value depends on the weight of the hybrid vehicle, for example. Alternatively or additionally, the specified limit value can consider the distance traveled by the hybrid vehicle. This means, for example, that an activation of the generator unit can initially be prevented or the generator unit can be switched off after a certain duration or a certain emission that is above the specified limit value. If the hybrid vehicle then continues to drive and is used exclusively in the sense of an electric vehicle, the generator unit can be reactivated by the control unit after a sufficiently long distance has been traveled using only the power from the battery, without the hybrid vehicle's emissions exceeding the specified limit value over the distance traveled. In particular, the specified limit value for emissions can be combined with the above-described consideration of the distance traveled by the hybrid vehicle with the generator unit activated. In a serial hybrid vehicle in particular, the emission can be determined by the duration of the activation of the generator unit, as the internal combustion engine of the generator unit is usually operated at a constant rotational speed in an optimum and constant power range.

Preferably, the control unit is configured to control the generator unit dependent on or as a function of the distance in a specified period. In particular, the control unit is therefore configured to control the generator unit as a function of the distance traveled purely electrically or the distance traveled with the generator unit activated in a specified period. Preferably, a specified limit value for the distance traveled by the hybrid vehicle with the generator unit activated or an emission generated over the distance traveled by the hybrid vehicle for a specified period is considered. In particular, this specified period comprises one day, one week, one month or one year. If the specified period is one year, for example, and the distance traveled by the hybrid vehicle with the generator unit activated exceeds a limit value specified for this purpose, for example, the control unit prevents the generator unit from being activated for the remaining period, i.e. the rest of the year, provided that no compensation by a sufficient distance traveled purely electrically or with zero emissions is made. This means that the hybrid vehicle can then be used exclusively in the sense of an electric vehicle. The internal combustion engine of the generator unit is no longer started if the charge state of the battery falls below a specified charge level. Rather, it is then necessary to charge the battery of the hybrid vehicle conventionally by connecting the hybrid vehicle to a power grid. In particular, this makes it possible to comply with an emission limit specified for the respective period (e.g. CO₂ emissions in kg/year). In particular, if the distance traveled falls below a specified limit value, the limit value for the subsequent period is adjusted and, in particular, increased. If there is still a certain distance for a specified period that can be traveled by the hybrid vehicle, particularly with the generator unit activated, the limit value for the subsequent period may be increased by this certain distance so that the generator unit can be used for a longer distance in the subsequent period. This results in a balancing between the individual periods, so that low-emission driving in one period increases the potential use of the hybrid vehicle in a subsequent period. This can be an immediately subsequent period or an accumulation over the periods, so that falling below a specified limit value of the distance traveled in a previous period is also taken into account in a later period.

In another aspect of the present invention, a method for reducing emissions of a hybrid vehicle is provided. Here, the hybrid vehicle comprises an electric motor for moving the hybrid vehicle and a battery, wherein the battery is connected to the electric motor and supplies the electric motor with power. Furthermore, the hybrid vehicle comprises a generator unit, wherein the generator unit comprises an internal combustion engine and a generator connected to the internal combustion engine, wherein the generator converts the kinetic energy of the internal combustion engine into power to operate the electric motor or for storage in the battery. In particular, the hybrid vehicle is configured as described above. Here, the method comprises the following steps:
detecting a distance traveled by the hybrid vehicle, and
controlling the generator unit dependent on or as a function of the distance traveled.

Preferably, the distance traveled includes the distance traveled with the generator unit activated. In particular, an activation of the generator unit is prevented if the distance traveled exceeds a specified limit value for a specified period. Here, the specified period can be one day, one week, one month or one year. In particular, the distance traveled here includes the distance traveled by the hybrid vehicle with the generator unit activated, so that the distance traveled with the generator unit activated can be limited and operation of the hybrid vehicle in the sense of a conventional combustion vehicle is prevented.

Preferably, the emissions generated are detected over the distance traveled. This can be derived from the fuel consumption of the generator unit, for example. Alternatively, engine parameters such as the rotational speed of the internal combustion engine of the generator unit can also be used, as the engine is usually operated with a substantially constant load. Thus, the generator unit can be controlled dependent on or as a function of the emissions generated over a distance traveled by the hybrid vehicle. For example, if the emissions exceed a specified limit value over the distance traveled, the generator unit is switched off and further activation is prevented until the value falls below the limit value again, in particular by traveling a distance using only electrical energy from the battery and thus operating the hybrid vehicle as an electric vehicle.

Preferably, the method is further developed using the features of the hybrid vehicle described above.

In a further aspect of the present invention, a method for operating a fleet of vehicles is provided. Here, the fleet comprises at least one hybrid vehicle, which is designed as described above. In particular, the fleet can include different vehicles, i.e. conventional combustion vehicles, purely electric vehicles or other emission-free vehicles such as hydrogen vehicles. In particular, the vehicles can all be designed identically. Alternatively, at least two vehicles differ in their design. Preferably, all vehicles are hybrid vehicles. In particular, the fleet of hybrid vehicles comprises exclusively serial hybrid vehicles as described above. It is particularly preferable for the fleet to consist exclusively of hybrid vehicles designed as described above.

Preferably, at least one of the hybrid vehicles in the fleet, several or all of the hybrid vehicles in the fleet are controlled dependent on or as a function of the accumulated distance traveled by the vehicles in the fleet. Thus, according to the method, the common distance traveled by the vehicles in the fleet is considered to control the individual hybrid vehicles. If, for example, the distance traveled by the vehicles in the fleet exceeds a specified common limit value, the generator unit of one of the hybrid vehicles in the fleet, several or all hybrid vehicles in the fleet is switched off or an activation of the corresponding generator units is prevented. This ensures that accumulated emissions across the entire fleet do not exceed a specified limit value. In particular, when using one or more of the hybrid vehicles in the fleet in the sense of an electric vehicle or by the zero-emission vehicles in the fleet, it is possible that the thus reduced emissions or distance traveled by these vehicles without a generator unit can be used by other hybrid vehicles in the fleet, so that the range of these hybrid vehicles can be increased by using the generator unit. This means that the distances traveled and emissions generated are balanced across the entire fleet, so that individual vehicles that generate higher emissions can be compensated for by vehicles in the fleet that are below the emission limit value.

Furthermore, the method of operating the fleet of vehicles is further developed using the features of the hybrid vehicle as described above and/or according to the method as described above.

### BRIEF DESCRIPTION OF THE DRAWINGS

The terms Fig., Figs., Figure, and Figures are used interchangeably in the specification to refer to the corresponding figures in the drawings.

In the following, the invention is described in more detail by means of preferred embodiments with reference to the accompanying figures.

In the Figures:

FIG. 1 is a schematic illustration of a hybrid vehicle according to the present invention,

FIG. 2 is a schematic flow diagram for operating a hybrid vehicle according to FIG. 1,

FIG. 3 is a detailed illustration for controlling the hybrid vehicle according to the present invention, and

FIGS. 4A-4C are detailed illustrations of embodiments of the hybrid vehicle according to the present invention.

### DESCRIPTION OF THE INVENTION

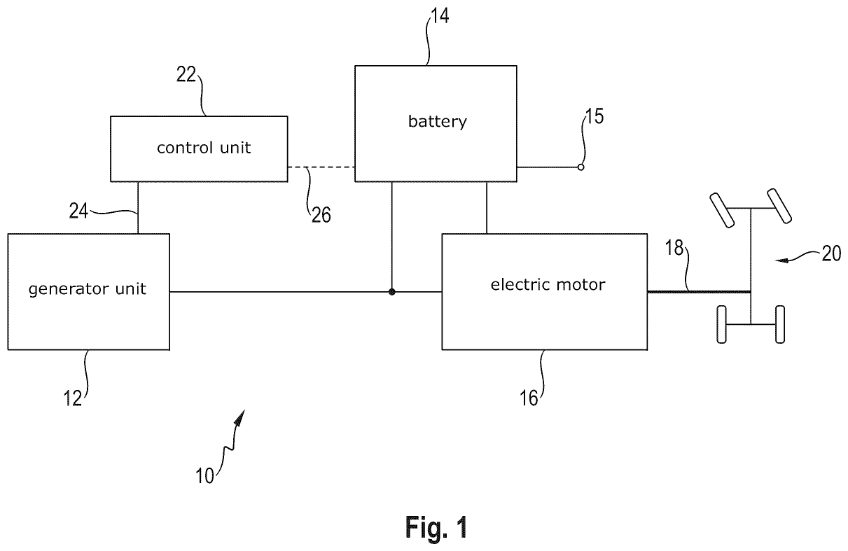

Hereinafter, reference is made to FIG. 1. The hybrid vehicle 10 comprises a drive train 20 with drive wheels. The drive train 20 is driven by an electric motor 16 via a mechanical connection 18. The electric motor 16 is connected to a battery 14, wherein the battery 14 provides power for the electric motor 16 to operate the electric motor 16 and to drive the drive train 20 of the hybrid vehicle 10. Furthermore, according to the invention, the hybrid vehicle 10 comprises a generator unit 12. Here, the generator unit 12 comprises an internal combustion engine and a generator, wherein the kinetic energy generated by the internal combustion engine is converted into electrical energy by the generator. The electric motor 16 can be operated using the electrical energy generated by the generator unit 12. Alternatively, the power generated by the generator unit 12 is stored in the battery 14. This is a serial structure of a hybrid vehicle. In particular, the generator unit 12 serves as a “range extender”, which is intended to extend the limited range of the battery 14 by using an internal combustion engine. There is no mechanical connection between the generator unit 12 and the drive train 20. The kinetic energy of the internal combustion engine of the generator unit 12 is thus not converted directly into a movement of the drive wheels of the drive train 20, but instead the power generated is used indirectly by the electric motor 16 either by direct transmission from the generator unit 12 to the electric motor 16 or by indirect transmission, wherein in the case of indirect transmission the electrical energy generated by the generator unit 12 is stored in the battery 14 and is then passed on to the electric motor 16 as required.

According to the invention, the hybrid vehicle 10 comprises a control unit 22. The control unit is connected to the generator unit 12 via a connection 24. In addition, the control unit 22 may be connected to the battery 14 by a second connection 26, which is indicated by the dashed line of the connection 26, so that the control unit can detect a charge state of the battery 14. For example, the control unit 22 can be configured to activate the generator unit 12 dependent on or as a function of the charge state of the battery or the charge level of the battery 14 in order to provide sufficient power for the electric motor 16. Furthermore, the control unit can take over further tasks within the hybrid vehicle 10.

Thus, the battery 14 can either be charged by the generator unit 12, or the power provided by the battery 14 can be boosted or replaced by the generator unit 12. Here, the battery 14 comprises a charging connection 15 so that the battery 14 can also be charged by connecting the charging connection 15 to a power grid. Thus, the hybrid vehicle 10 of the present invention can be operated as a pure electric vehicle, which generates its movement solely from the combination of the battery 14 and the electric motor 16 to drive the drive train 20, wherein the battery is charged by means of the charging connection 15. Furthermore, it is also possible to operate the hybrid vehicle via the generator unit 12, wherein the internal combustion engine of the generator unit 12 is activated to generate the electrical energy, which is converted by the electric motor 16 into a movement of the drive wheels of the drive train 20. It is therefore also possible to operate the hybrid vehicle 10 as a pure combustion vehicle. However, this results in unintentionally high emissions and at the same time turns the advantage of the hybrid vehicle 10 into a disadvantage, as additional weight is generated by the battery 14 and the electric motor 16 that also have to be moved by the internal combustion engine.

Thus, according to the invention, the control unit 22 is configured to control the generator unit 12 dependent on or as a function of the distance traveled by the hybrid vehicle 10. For this purpose, the control unit 22 is configured to detect the distance traveled by the hybrid vehicle 10. This can be done, for example, by an odometer that is directly connected to one of the drive wheels. Alternatively or additionally, the distance traveled can also be detected using a satellite navigation system (GNSS), such as GPS, Galileo or the like. A suitable control of the generator unit 12 can then be derived from the thus detected distance traveled by the hybrid vehicle 10. Here, the control unit 22 in particular detects the distance traveled with the generator unit 12 activated or the emissions caused. By taking into account the distance traveled, it is possible to prevent unintentional operation of the hybrid vehicle as a conventional combustion vehicle. This allows the emissions of the hybrid vehicle 10 to be further reduced and, in particular, specified emission limit values can be complied with.

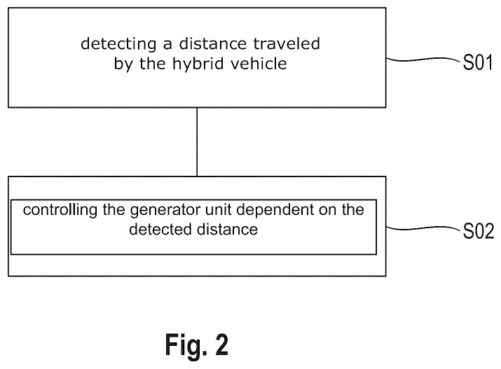

FIG. 2 shows a schematic flow diagram for a hybrid vehicle according to FIG. 1 for reducing the emissions of such a hybrid vehicle. The method comprises the following steps:
In step S01, a distance traveled by the hybrid vehicle is detected.
In step S02, the generator unit is controlled dependent on the detected distance.

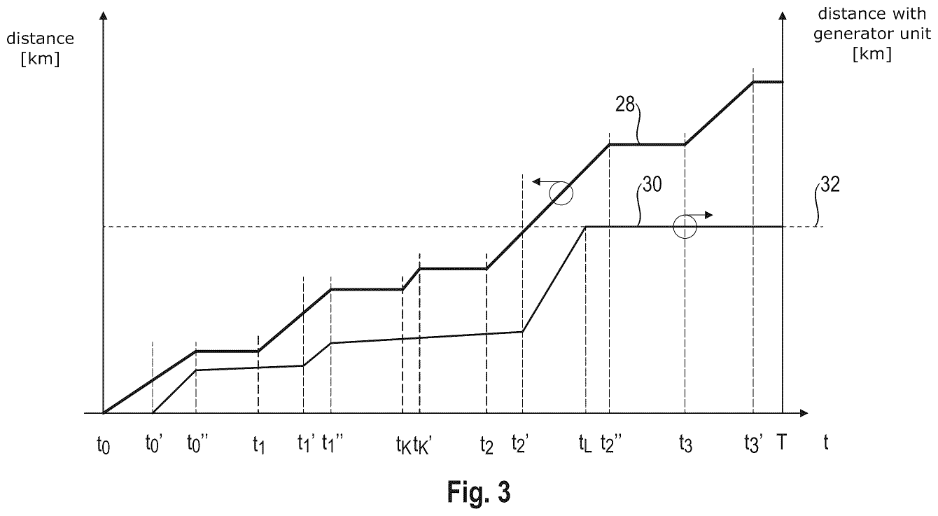

In the following, reference is made to FIG. 3, which shows an exemplary illustration of the method. Here, line 28 shows the distance traveled by the hybrid vehicle 10 plotted against time t. Line 30 shows the distance traveled by the hybrid vehicle with activated generator unit 12 in the same units. Here, the time t extends over a period T. The period T refers to an assessment period within which a specific limit value 32 for a distance traveled by the hybrid vehicle 10 with the generator unit 12 activated must not be exceeded. The specified period T can correspond to a day, a week, a month, a year or another period.

The hybrid vehicle is moved in a first period from t₀ to t₀″ and in a second period from t₁ to t₁″. There, the generator unit 12 is activated in a first period from t₀′ to t₀″ and in a second period from t₁′ to t₁″. Both the kilometers driven and the kilometers traveled with the generator unit activated add up. Between these areas are time sections in which the vehicle is not moved. In the period between tₖ and tₖ′, the hybrid vehicle 10 travels a short distance during which the generator unit 12 is not activated. In the range between t₂ and t₂″, the hybrid vehicle is driven again and the generator unit 12 is activated at a time t₂′. However, at time t_{L}, the distance traveled with the generator unit 12 activated reaches the limit value 32 and the generator unit 12 is switched off or further activation of the generator unit 12 is prevented by the control unit 22. In a later period between t₃ and t₃′, the generator unit 12 is therefore not reactivated. Thus, in the period T starting from the time t_{L} at which the distance traveled by the hybrid vehicle with the generator unit 12 activated reaches the limit value 32, the generator unit 12 is no longer activated and no more emissions are generated as long as there is no compensation by a sufficiently long emission-free distance. As an alternative to compensation, it would also be conceivable that the limit value could be increased by paying a levy or a corresponding toll. At the end of period T, a new period starts so that the generator unit 12 can be reactivated until it reaches the limit value 32 again. Here, the successive periods T are in particular constant. If the limit value 32 is not reached in a first period T₁, the limit value for a subsequent period T₂ can be adjusted accordingly. In particular, the limit value of the subsequent period T₂ is increased by the distances by which the distance traveled with the generator unit 12 activated within the first period T₁ is below the limit value 32. This results in a balancing over the individual periods, and a continuous limitation of the emissions of the hybrid vehicle 10 is achieved.

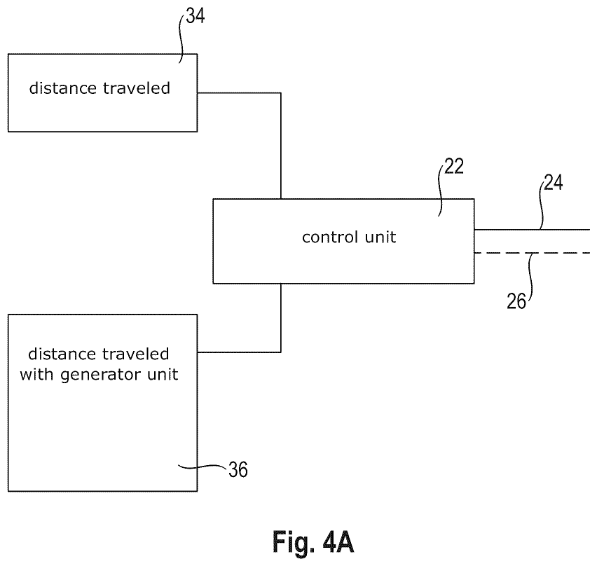

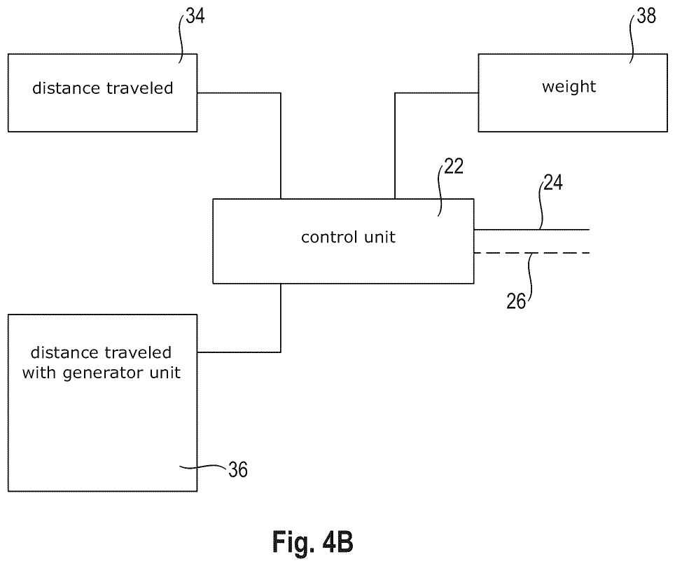

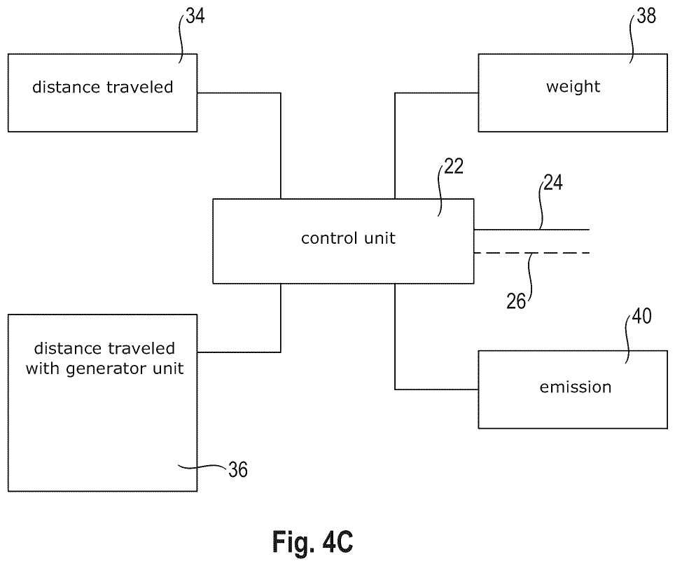

Reference is made to FIG. 4A. Here, the control unit 22 is connected to a module 34 for detecting the distance traveled and to a module 36 for detecting the distance traveled with the generator unit activated. If the absolute value of the distance traveled with the generator unit activated or the ratio between the distance traveled and the distance traveled with the generator unit activated exceeds a specified limit value, the control unit is configured to switch off the generator unit 12 and prevent further activation of the generator unit 12 for the specified period.

In the embodiment of FIG. 4B, the weight is also taken into account via a weight detection module 38. Here, the weight can be detected, for example, via an air suspension of the hybrid vehicle, wherein the pressure applied to the air suspension can be used to determine the weight of the hybrid vehicle 10. As emission limit values are often specified in relation to the weight of the vehicle (e.g. CO₂ emitted in kg per weight in t and per distance driven in km), the weight can be taken into account when adjusting the limit value 32. For example, it can be achieved that empty driving of the hybrid vehicle, which usually have a low weight, have a higher proportion of purely electrically traveled kilometers, whereas in the fully loaded state, due to the higher weight, the control unit 22 is configured to allow activation of the generator unit 12 over a longer distance.

In FIG. 4C, the actual emission 40 caused by the generator unit 12 is also taken into account. Thus, the actual emission caused can be considered and an emission limit value can also be used, for example, dependent on or as a function of the weight 38 and/or the distance traveled 34, above which the control unit 22 is configured to switch off the generator unit 12 or to avoid reactivation.

Thus, the present invention provides a hybrid vehicle that causes fewer emissions, since the hybrid vehicle is predominantly used as an electric vehicle and the generator unit is only used as a support in the sense of a “range extender” and does not replace the emission-reducing electric mobility.

1. A hybrid vehicle, in particular for the transportation of general cargo or shipments, comprising
an electric motor to move the hybrid vehicle,
a battery, wherein the battery is connected to the electric motor and supplies the electric motor with power,
a generator unit, wherein the generator unit comprises an internal combustion engine and a generator connected to the internal combustion engine, wherein the generator converts the kinetic energy of the internal combustion engine into power to operate the electric motor or for storage in the battery, and
a control unit, wherein the control unit is connected to the generator unit and is also configured to determine the distance traveled by the hybrid vehicle,
wherein the control unit is also configured to control the generator unit dependent on the distance traveled by the hybrid vehicle.

2. The hybrid vehicle according to claim 1, wherein the control unit is configured to control the generator unit dependent on the distance traveled by the hybrid vehicle with the generator unit activated.

3. The hybrid vehicle according to claim 2, wherein the control unit is configured to prevent an activation of the generator unit if the distance traveled by the hybrid vehicle with the generator unit activated exceeds a specified limit value.

4. The hybrid vehicle according to claim 1, wherein the control unit is configured to control the generator unit dependent on the emissions generated by the hybrid vehicle over the distance traveled.

5. The hybrid vehicle according to claim 4, wherein the control unit is configured to prevent an activation of the generator unit if the emission generated by the hybrid vehicle over the distance traveled exceeds a specified limit value.

6. The hybrid vehicle according to claim 1, wherein the control unit is configured to control the generator unit dependent on the distance in a specified period.

7. The hybrid vehicle according to claim 6, wherein the control unit adjusts the limit value of the subsequent period when the distance traveled falls below a specified limit value.

8. A method for reducing the emissions of a hybrid vehicle, the hybrid vehicle comprising:
an electric motor to move the hybrid vehicle,
a battery, wherein the battery is connected to the electric motor and supplies the electric motor with power, and
a generator unit, wherein the generator unit comprises an internal combustion engine and a generator connected to the internal combustion engine, wherein the generator converts the kinetic energy of the internal combustion engine into power to operate the electric motor or for storage in the battery,
the method comprising the following steps:
detecting a distance traveled by the hybrid vehicle, and
controlling the generator unit dependent on the distance traveled.

9. The method according to claim 8, wherein the distance traveled comprises the distance traveled with the generator unit activated.

10. The method according to claim 9, wherein an activation of the generator unit is prevented if the distance traveled exceeds a specified limit value for a specified period.

11. A method of operating a fleet of vehicles, wherein the fleet comprises at least one hybrid vehicle according to claim 1.

12. The method according to claim 11, wherein at least one of the hybrid vehicles in the fleet is controlled dependent on the accumulated distance traveled by the vehicles in the fleet.
